(19) United States
(12) Patent Application Publication
(10) Pub. No.: US 2003/0059059 A1
(43) Pub. Date: Mar. 27, 2003

(54) Sound

(76) Inventors: Eric David Supinski, Springfield, MA (US); Jason Paul D'Amours, Springfield, MA (US)

Correspondence Address: Eric D. Supinski, 14 Van Ness Street, Springfield, MA, 01107, US

(21) Appl. No.: 09/963,707

(22) Filed: Sep. 27, 2001

(51) Int. Cl. H04B 3/00; H04R 1/02; H04R 9/06

(52) U.S. Cl. 381/87; 381/333; 381/77

(57) ABSTRACT

This invention of a portable speaker system has features that make it unique. The adjustable speaker positioning to your preference. The ability to inter-connect. The clamps that allow for attachment to your chair of choice. All these features together make this invention one of a kind.

### CROSS-REFERENCE TO RELATED APPLICATIONS

N/A

### STATEMENT REGARDING FEDERALLY SPONSORED RESEARCH OR DEVELOPMENT

N/A

### REFERENCE TO MICROFICHE APPENDIX

N/A

### BACKGROUND OF INVENTION

1. Field of Invention

This invention of a portable speaker system is related to anyone who has a portable audio player that finds wearing headphones a problem while sitting in a chair.

2. Description of Prior Art

N/A

### SUMMARY OF THE INVENTION

Our invention of this type of portable speaker system allows people to enjoy the sounds of music without using headphones. The lightweight durable design has primary features that make it one of a kind and is summarized as follows:

The portable speaker system has two adjustable clamps that allows it to be attached to various styles of chairs and the clamps require no tools for this process.

The speakers are affixed on flexible metal tubing which allows for adjustable positioning according to personal preference.

This product also contains a female style stereo plug which allows for more than one The Sound to be used on a single portable audio player.

### BRIEF DESCRIPTION OF THE DRAWINGS

For a better understanding of the invention, there are drawings that show different views. These views will assist on the detailed description of the invention.

FIG. 1 is a front view;

FIG. 2 is a back view;

FIG. 3 is a perspective front view;

FIG. 4 is a left side view.

FIG. 5 is a back sectional exploded view to show wiring in designated project box.

FIG. 6 is a front sectional exploded view to show wiring of speakers in designated project box. (typical of two)

### DESCRIPTION OF THE PREFERRED EMBODIMENT

Referring to FIGS. The reference numerals show the different parts in the process of assembly.

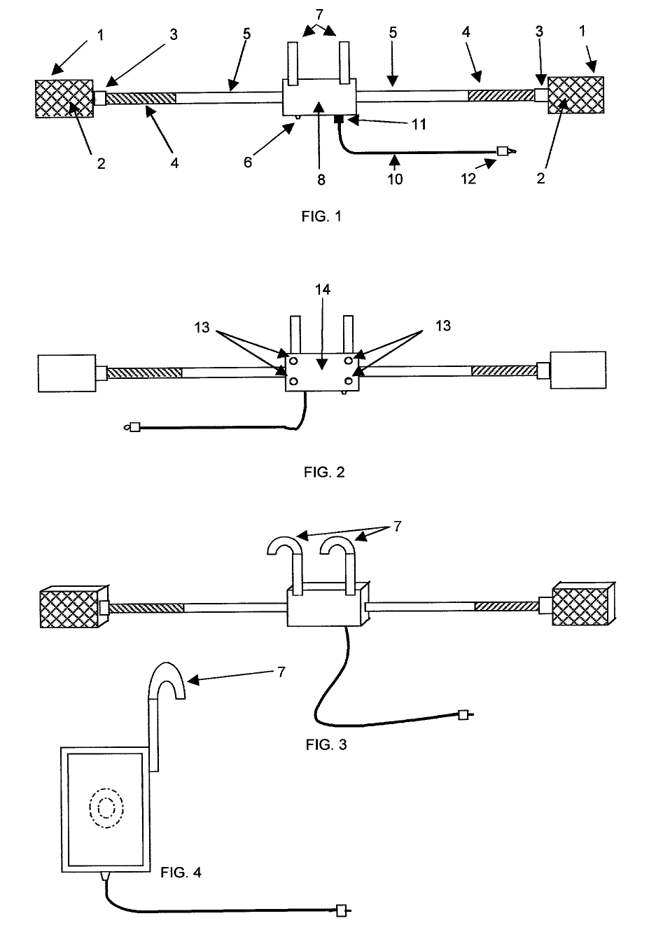

Referring to FIG. 1. The plastic project box 8 has two holes, one on the left side and one on the right side. These holes are for the flexible metal tubing compression stem connectors 5, the threaded side of the flexible metal tubing compression stem connector is placed into the plastic project box 8 and secured by using a lock washer and nut. On the compression side of the flexible metal tubing compression stem connector 8, attach the flexible metal tubing 4 using a crimping tool. Attach a flexible metal tubing connector 3 to the other side of the flexible metal tubing 4 using a crimp tool. The plastic project boxes 1 have one hole on the side to accept the threaded part of the flexible metal tubing connector, which are secured with a lock washer and nut. By using flexible metal tubing 4, it allows for adjustable speaker positioning.

Referring to FIG. 3 and FIG. 4, the reference numerals point to the rubber lined metal clamps 7. FIGS. 3 and 4 show the rubber lined metal clamps fastened to the front of project box 8. The rubber lined metal clamps 7 let the invention to be attached and secured to various styles of chairs without the use of tools.

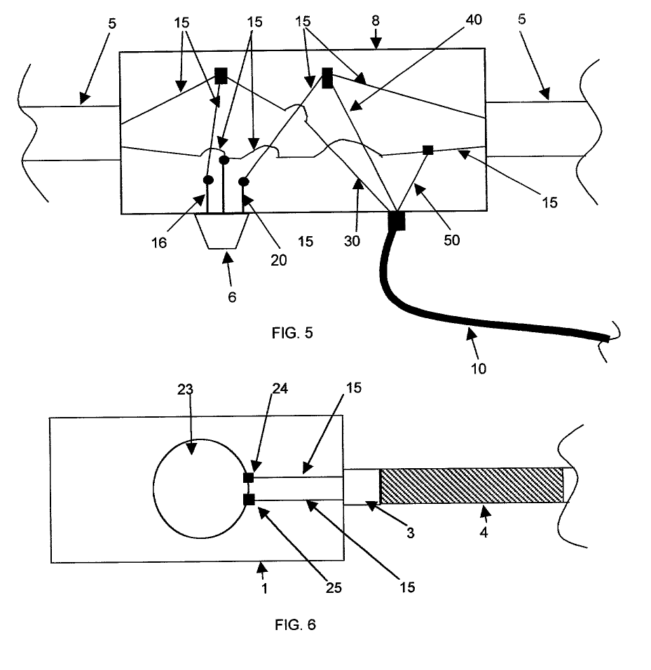

Referring back to FIG. 1. The female style stereo plug 6 is secured in the left hole of the two holes on the bottom of the plastic project box 8, which is wired internally (refer to FIG. 5). Adding the female style stereo plug 6 allows for inter-connecting for more than one of this invention into another.

Referring back to FIG. 1. The three conductor wire 10 with a male style plug 12 is passed through the right hand hole on the bottom of the project box 8 and secured with a rubber bushing. The wiring is spliced internally (refer to FIG. 5). The male style plug 12 allows the invention to be used with any audio equipment that has a female style plug of this type.

Referring to FIG. 6. The speaker 23 is fastened to the inside of the plastic project box 1. On the speaker 23 there are two soldering points, a positive terminal 24 and a negative terminal 25. Two pieces of wire 15 are passed from plastic project box 8 to plastic project box 1 through the stem assembly 3,4,5. On the positive terminal 24 of the speaker solder one of the wires 15. On the negative terminal solder the other wire 15. This process is typical of two.

Referring to FIG. 5 and FIG. 6. The female style stereo plug 6 has three terminals, a left positive terminal 16, a right positive terminal 20 and a negative terminal 18. Solder a piece of wire 15 onto the left positive terminal 16, splice this wire 15 with wire 15 soldered onto the positive terminal 24 from left side speaker 24 and left positive wire 30 from three conductor wire 10 together.

Referring to FIG. 5 and FIG. 6. Solder a piece of wire 15 onto right positive terminal 20, splice this wire 15 with wire 15 soldered onto the positive terminal 24 from the right side speaker 23 and right positive wire 40 from three conductor wire 10 together.

Referring to FIG. 5 and FIG. 6. Solder a piece of wire 15 onto the negative terminal 50, splice this wire 15 with wire 15 soldered onto the negative terminal 25 from left and right side speakers 23 and wire 50 from three conductor wire 10 together.

Referring to FIG. 1 and FIG. 2. Secure the back plate 14 onto the plastic project box 8 with screws 13. Finally fasten speaker guard 2 to plastic project box 1 (typical of two).

1. What I (we) claim as my invention is a portable speaker system, compromising:
A pair of rubber lined metal clamps.
Adjustable speaker positioning due to the flexible metal tubing.
Means of interconnecting due to the female style stereo type plug.
